(19) United States
(12) Patent Application Publication
(10) Pub. No.: US 2018/0177192 A1
(43) Pub. Date: Jun. 28, 2018

(54) Seed Treatment Composition

(71) Applicant: TALC USA, LLC, Page, ND (US)

(72) Inventor: Steven Bruce Johnson, Page, ND (US)

(73) Assignee: TALC USA, LLC

(21) Appl. No.: 15/391,498

(22) Filed: Dec. 27, 2016

(51) Int. Cl. A01N 63/00; A01N 43/653; A01N 43/54; A01C 5/06; A01C 7/12; A01C 1/06

(52) U.S. Cl. CPC A01N 63/00; A01N 43/653; A01C 1/06; A01C 5/062; A01C 7/12; A01N 43/54

(57) ABSTRACT

A seed treatment composition which efficiently applies a seed treatment material such as a bacterium or plant protein to a seed by using a talc-based carrier material. The seed treatment composition generally includes a carrier material which is mixed with a seed treatment material and applied to a seed such that the carrier material and seed treatment material both adhere to and uniformly coat the exterior surface of the seed. The carrier material will generally include talc which mixes with the seed treatment material and adheres to the exterior of the seed. The seed treatment material may comprise any solid, particulate material which would benefit a seed, such as an inoculant, bacterium, plant proteins, insecticide, and/or fungicide.

### CROSS REFERENCE TO RELATED APPLICATIONS

Not applicable to this application.

### STATEMENT REGARDING FEDERALLY SPONSORED RESEARCH OR DEVELOPMENT

Not applicable to this application.

### BACKGROUND

### Field

Example embodiments in general relate to a seed treatment composition and method which efficiently applies a seed treatment material such as a bacterium or plant protein to a seed by using a talc-based carrier material.

### Related Art

Any discussion of the related art throughout the specification should in no way be considered as an admission that such related art is widely known or forms part of common general knowledge in the field.

Since the dawn of agriculture, farmers have utilized various methods and compositions to treat seeds in an effort to encourage healthy growth of the seed into a plant. Seeds may be treated with inoculants such as bacterium which may encourage healthy growth by maximizing nitrogen availability if nitrogen in the growing medium is low. Seeds may be treated with plant proteins which may encourage healthy grown by providing the amino acids utilized in germination and seedling growth.

Additional seed treatments may also be applied to seeds which ward off various organisms and the like that could inhibit growth of the seed into a plant. Seeds may be treated with insecticides to prevent various insects from feeding on the plant as it grows. Seeds may be treated with fungicides to prevent growth of harmful fungi on the plant as it grows. Seeds may also be treated with herbicides to prevent growth of harmful or unwanted vegetation in the growing medium surrounding the plant.

Seed treatments such as inoculants, plant proteins, insecticides, herbicides, and fungicides have been in use for many years to encourage healthy growth of the seed into a plant. These seed treatments have typically in the past been applied to the seed via a liquid carrier and are commonly available in liquid form. The liquid form of these seed treatments can be difficult to handle, which can increase risk to farmers due to the liquid sloshing around during application to the seeds; particularly if the seed treatment material is toxic. Additionally, the liquid form of these seed treatments lacks various benefits which are gained by instead using a solid form of seed treatments as discussed in more detail here. Many of the liquid forms of seed treatments may also limit the effective life of inoculants and the like which are applied to the seeds.

While there have been solid forms of seed treatment materials, seed treatment materials have not typically been applied to seeds using a solid particulate form. Where seed treatment materials have been applied to seeds using a solid particulate form, the solid particulates used have not provided a number of benefits to the seed and planting process which are inherent with the use of a talc-based carrier material as described herein.

Previous methods and compositions for applying seed treatment materials have not acted as a lubricant which coats the seed. The seed will preferably be able to traverse the systems of the planter without any drag resulting from contact of the seed with the interior of the planter. Such drag will negatively impact seed spacing—if the seed is encountering drag in the planter's systems, then the set seed spacing by the farmer will not be achieved as there will be a larger space in between seeds due to the drag on the seed.

The seed coating will preferably act as a hydrophobe. Hydrophobic materials disperse surrounding moisture. Moisture within the air system of a planter may inhibit the planting operation or the planted seeds. Liquid-based seed treatments actually may introduce such moisture into an air system. A hydrophobic carrier material, which is mixed with the seed treatment to apply to a seed, will transfer the hydrophobic properties to the exterior of the seed, which in turn aids in removing moisture from the air system of the planter.

The seed coating will also preferably have anti-static properties. Static build-up and discharge within a planter may negatively impact operation of the planter and/or negatively impact growth and health of the seed. Liquid-based seed treatments may encourage static electricity depending on their state after drying on the seed. Where solid-based seed treatments have been used, they also may encourage static electricity if the seed treatment material does not have such anti-static properties.

Where previous solid-based carrier materials have been used, they have not exhibited the necessary lubricant, hydrophobic, or anti-static properties to ensure a smooth and efficient planting operation which does not damage the seed, any seed treatment being applied to the seed, or the planter itself.

It would be preferable to utilize a solid carrier to apply a solid seed treatment to a seed which has the property of lubricating the exterior of the seed to aid in traversing the planter's internal systems. It is also preferable that a solid carrier be used which may act as a hydrophobe to remove moisture from the air system of the planter. Finally, it is preferable that a solid carrier be used which may have anti-static properties to prevent accumulation or discharge of static electricity within the planter's system.

It has been found that talc includes the desired lubricant, hydrophobic, and anti-static properties to aid the seed in traversing the planter without drag, moisture, or static accumulation/discharge. The applicant has applied talc-based coatings to seeds in the past to reduce drag on the seed, disperse air moisture within a planter's air systems, and/or to prevent static accumulation or discharge within the planter.

The Applicant has previously incorporated some micronutrients to seeds by including such micronutrients mixed with the talc. For example, iron, manganese, and graphite have been included with talc for their micronutrient properties prior to application of the talc to a seed. However, talc-based coatings have not previously been used to apply a seed treatment material to a seed.

The benefits of applying a solid-based seed treatment material to a seed by using a solid, talc-based carrier material have previously been unknown. The Applicant, through significant testing and experimentation, has determined that a talc-based carrier material may be mixed with a solid seed treatment material where the carrier material and the seed treatment material each comprise a substantially similar particulate size. This method of applying such a seed treatment composition has been shown to improve the effective life of the seed treatment composition as well as encourage the hydrophobic, lubricant, and anti-static properties described above.

### SUMMARY

An example embodiment of the present invention is directed to a seed treatment composition. The seed treatment composition includes a carrier material which is mixed with a seed treatment material and applied to a seed such that the carrier material and seed treatment material both adhere to and uniformly coat the exterior surface of the seed. The carrier material will generally include talc which mixes with the seed treatment material and adheres to the exterior of the seed. The seed treatment material may comprise any solid, particulate material which would benefit the seed, such as an inoculant, bacterium, plant proteins, insecticide, and/or fungicide.

There has thus been outlined, rather broadly, some of the features of the seed treatment composition in order that the detailed description thereof may be better understood, and in order that the present contribution to the art may be better appreciated. There are additional features of the seed treatment composition that will be described hereinafter and that will form the subject matter of the claims appended hereto. In this respect, before explaining at least one embodiment of the seed treatment composition in detail, it is to be understood that the seed treatment composition is not limited in its application to the details of construction or to the arrangements of the components set forth in the following description or illustrated in the drawings. The seed treatment composition is capable of other embodiments and of being practiced and carried out in various ways. Also, it is to be understood that the phraseology and terminology employed herein are for the purpose of the description and should not be regarded as limiting.

### BRIEF DESCRIPTION OF THE DRAWINGS

Example embodiments will become more fully understood from the detailed description given herein below and the accompanying drawings, wherein like elements are represented by like reference characters, which are given by way of illustration only and thus are not limitative of the example embodiments herein.

FIG. 1 is a side sectional view of containers which include a carrier material, a seed treatment material, and untreated seeds.

FIG. 2 is a side sectional view of a container having seed treatment material being poured into a container having carrier material.

FIG. 3 is a side sectional view of a container storing both seed treatment material and carrier material.

FIG. 4 is a side sectional view illustrating the mixing of the seed treatment material with the carrier material by stirring.

FIG. 5 is a side sectional view illustrating shaking of the container to mix the seed treatment material with the carrier material.

FIG. 6 is a side sectional view of a container storing the seed treatment composition and a container storing untreated seeds.

FIG. 7 is a side sectional view of a container of untreated seeds being poured into a container of seed treatment composition.

FIG. 8 is a side sectional view illustrating application of the seed treatment composition to the untreated seeds by stirring.

FIG. 9 is a side sectional view illustrating application of the seed treatment composition to the untreated seeds by shaking.

FIG. 10 is a side sectional view of a container storing coated seeds.

FIG. 11 is an illustrating showing the seed treatment composition being applied to an untreated seed to form a coated seed.

FIG. 12 is a side view illustrating coated seeds being transferred to a container on a planter.

FIG. 13 is a side sectional view of an auger being used to mix seed treatment with seeds as the seeds are fed into a planter.

FIG. 14 is a side view of coated seeds being planted using a planter.

FIG. 15 is a sectional view of a carrier particle and a seed treatment particle.

FIG. 16 is a sectional view illustrating the mixing of the carrier particle with the seed treatment particle.

FIG. 17 is a sectional view of a carrier particle mixed with a seed treatment particle.

FIG. 18 is a flowchart illustrating an exemplary method of mixing the carrier material with the seed treatment material.

FIG. 19 is a flowchart illustrating an exemplary method of mixing the carrier material with the seed treatment material by stirring.

FIG. 20 is a flowchart illustrating an exemplary method of mixing the carrier material with the seed treatment material by shaking a container.

FIG. 21 is a flowchart illustrating an exemplary method of applying the seed treatment material to the seeds.

FIG. 22 is a flowchart illustrating an exemplary method of adhering the carrier material to the seeds.

FIG. 23 is a flowchart illustrating the process of activating bacterium in the seed treatment material.

### DETAILED DESCRIPTION

### A. Overview.

An example seed treatment composition generally comprises a carrier material 22 which is mixed with a seed treatment material 32 and applied to a seed 42 such that the carrier material 22 and seed treatment material 32 both adhere to and uniformly coat the exterior surface of the seed 42. The carrier material 22 will generally include talc which mixes with the seed treatment material 32 and adheres to the exterior of the seed 42. The seed treatment material 32 may comprise any solid, particulate material which would benefit a seed 42, such as an inoculant, bacterium, plant proteins, insecticide, and/or fungicide.

A method of manufacturing the seed treatment composition 10 may comprise steps of providing a volume of the carrier material 22, providing a volume of the seed treatment material 32, combining the volume of the carrier material 22 with the volume of the seed material 32 in a container 15, 20, 30, 40, and mixing the carrier material 22 with the seed treatment material 32 in the container 15, 20, 30, 40. The mixing may be performed in a number of manners, including by stirring the volume of the carrier material 22 with the volume of the seed treatment material 32 within the container 15, 20, 30, 40 and/or shaking the container 15, 20, 30, 40 storing the carrier material 22 and the seed treatment material 32.

A method of applying the seed treatment composition 10 to a seed 42 may comprise the steps of providing a volume of the carrier material 22, providing a volume of the seed treatment material 32, providing a volume of seeds 42, mixing the volume of the carrier material 22 with the volume of the seed treatment material 32 to form the seed treatment composition 10, and uniformly coating each of the seeds 42 with the seed treatment composition 10 to form a plurality of coated seeds 44.

A method of using the seed treatment composition 10 may comprise steps of coating a plurality of seeds 42 with the seed treatment composition 10 to form a plurality of coated seeds 44, filling a container 15 of a planter 14 with the plurality of coated seeds 44, and planting the plurality of coated seeds 44 with the planter 14. If the seed treatment material 32 comprises a bacterium, the bacterium may be dormant until planted and then activated after being planted by the planter 14.

Both the carrier material 22 and the seed treatment material 32 are preferably comprised of a solid and thus are not liquid. Preferably, both the carrier material 22 and the seed treatment material 32 comprise solid particulate material such as a powder having particle sizes under 68 microns. The carrier material 22 and the seed treatment material 32 each preferably comprise a substantially similar particle size which aids in mixing and uniformly coating each seed.

The composition 10 and methods described herein may be applied to a wide range of different seed 42 types, such as legumes, corn, soy beans, and the like. Because the size and type of seed 42 may vary, different embodiments may utilize different particle sizes for the carrier material 22 and/or seed treatment material 32.

### B. Carrier Material.

The seed treatment composition 10 may utilize a carrier material 22 to coat the seed 42 with the seed treatment material 32. Various types of carrier materials 22 may be utilized. The carrier material 22 should be comprised of a particulate, solid material. Preferably, a seed treatment material 32 will be utilized which may serve as a lubricant to aid the seed 42 as it traverses any conduits or passageways during the planting process. The seed treatment material 32 will also preferably function as a hydrophobe to disperse any moisture within the planter's 14 air system. The seed treatment material 32 will also preferable have anti-static properties to prevent static accumulation and discharge within the planter 14.

One such exemplary carrier material 22 is comprised of talc. Talc has been found to have the lubricant, hydrophobic, and anti-static properties that are desirable for the carrier material 22. It should be appreciated that carrier materials 22 other than talc may be utilized in different embodiments. Preferably, whichever carrier material 22 utilized will be adapted to adhere to and uniformly coat the exterior of a seed 42.

The carrier material 22 may also comprise one or more micronutrients which are mixed with the carrier material 22. Exemplary micronutrients which could form part of the carrier material 22 include manganese, iron, and/or graphite. Such micronutrients may be mixed with the carrier material 22 at a time prior to the carrier material 22 being mixed with the seed treatment material 32 such that the micronutrients form part of the carrier material 22.

### C. Seed Treatment Material.

It is common to treat seeds 42 with various materials to encourage health of the plants grown from the seeds 42. Various types of seed treatment materials 32 may be mixed with the carrier material 22; with the carrier material 22 adhering the seed treatment material 32 to the exterior of the seed 42 such that the seed 42 is uniformly covered with both the carrier material 22 and the seed treatment material 32.

Exemplary seed treatment materials 32 which could be applied to a seed 42 via the carrier material 22 include inoculants, plant proteins, fungicides, herbicides, and/or insecticides. Combinations of the foregoing seed treatment materials 32 may also be utilized so long as the constituent seed treatment materials 32 do not interfere with each other.

i. Inoculant.

The seed treatment material 32 may comprise an inoculant which treats the seed 42 to improve its health and growth. An exemplary inoculant would be a bacterium which is added to the host seed 42 prior to planting. The bacterium may be dormant when applied to the seed; with the bacterium only activating after planting in the soil. It has been found that a talc-based carrier material 22 as disclosed herein may result in an increase in the window of effectiveness for various inoculants.

Various types of inoculants may be applied to the seed 42 with the carrier material 22. Further, various types of bacterium may be applied to the seed 42 with the carrier material 22. Exemplary bacterium includes azospirillum. Exemplary types of azospirillum which could be applied to the seed 42 with the carrier material 22 include azospirillum brasilense and/or azospirillum lipoferum. Additional bacterium which could be applied to the seed 42 with the carrier material include pantoea eucalypti, pseudomonad, bradyrhizobium japonicum, and rhizobium leguminosarum.

ii. Plant Protein.

The seed treatment material 32 may comprise a plant protein which encourages health and growth of the seed 42 into a plant, such as by providing amino acids utilized in germination and seedling growth. The carrier material 22 aids in applying the plant protein to the seed 42 in a uniform manner.

Various types of plant proteins may be utilized as or as part of the seed treatment material 32. The plant proteins may be utilized in combination with other seed treatment materials 32, such as bacterium, insecticides, fungicides, and/or herbicides. Exemplary plant proteins which may be applied to the seed 42 with the carrier material 22 include harpin proteins and myconate.

iii. Insecticide.

The seed treatment material 32 may comprise an insecticide which will prevent harmful insects and the like from feeding on or damaging the plant as it grows. The carrier material 22 will aid in applying the insecticide to the seed 42 in a uniform manner.

Various types of insecticides may be utilized as or as part of the seed treatment material 32. The insecticides may be utilized in combination with other seed treatment materials 32, such as bacterium, plant proteins, fungicides, and/or herbicides. The insecticide utilized should preferably comprise a solid particulate material such as ovicides and/or larvicides. Natural insecticides such as nicotine, pyrethrum, and neem extracts may also be utilized.

iv. Fungicide.

The seed treatment material 32 may comprise a fungicide which will prevent harmful fungi and the like from damaging the plant as it grows. The carrier material 22 will aid in applying the fungicide to the seed 42 in a uniform manner.

Various types of fungicides may be utilized as or as part of the seed treatment material 32. The insecticides may be utilized in combination with other seed treatment materials 32, such as bacterium, plant proteins, insecticides, and/or herbicides. The fungicide utilized should preferably comprise a solid particulate material. Exemplary fungicides include azoxystrobin, tebuconazole, metalaxyl, and clothianidin.

v. Herbicide.

The seed treatment material 32 may comprise an herbicide which will prevent harmful vegetation and the like from damaging the plant as it grows. The carrier material 22 will aid in applying the fungicide to the seed 42 in a uniform manner.

Various types of herbicides may be utilized as or as part of the seed treatment material 32. The herbicide may be utilized in combination with other seed treatment materials 32, such as bacterium, plant proteins, insecticides, and/or fungicides. The herbicide utilized should preferably comprise a solid particulate material. Exemplary herbicides include sulfentrazone, dicamba, and glyphosate.

### D. Method of Manufacturing the Seed Treatment Composition.

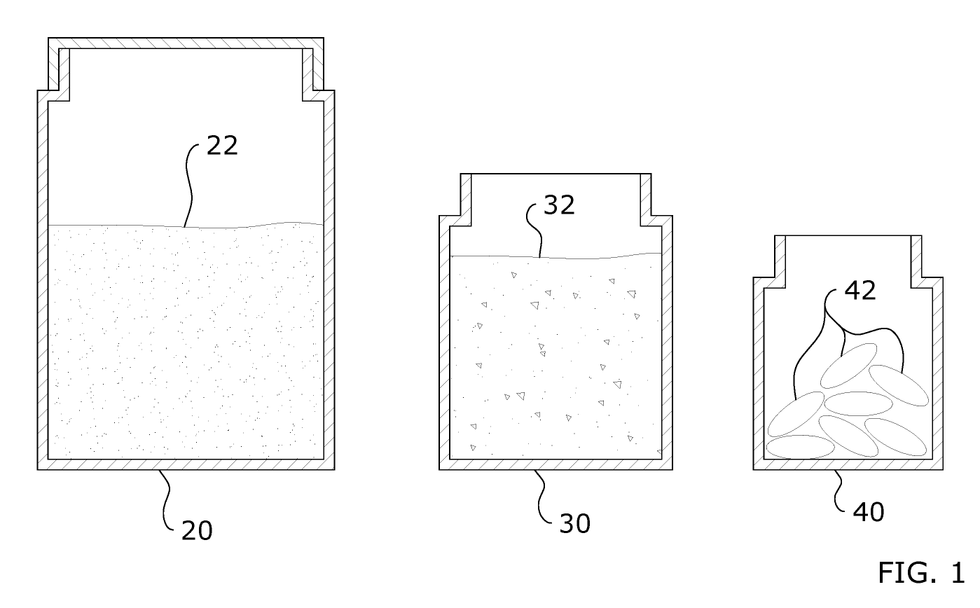

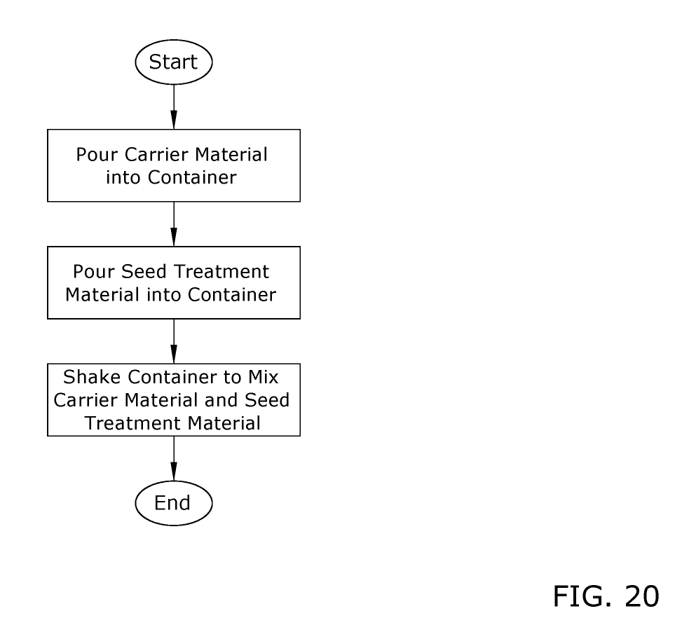

FIGS. 1-5, 11, 15-17, and 20 illustrate various methods of manufacturing the seed treatment composition 10. It should be appreciated that the figures and description herein are merely for exemplary purposes; and thus various other methods of manufacture may be utilized to combine the carrier material 22 with the seed treatment material 32.

The method of manufacturing the seed treatment composition 10 may include providing a volume of the carrier material 22, providing a volume of the seed treatment material 32, combining the volume of the carrier material 22 with the volume of the seed material 32 in a container 15, 20, 30, 40, and mixing the carrier material 22 with the seed treatment material 32 in the container 15, 20, 30, 40. The mixing may be performed in a number of manners as described below, including by stirring the volume of the carrier material 22 with the volume of the seed treatment material 32 within the container 15, 20, 30, 40 and/or shaking the container 15, 20, 30, 40 storing the carrier material 22 and the seed treatment material 32.

FIG. 1 illustrates a first container 20 storing a volume of carrier material 22, a second container 30 storing a volume of seed treatment material 32, and a third container 40 storing a volume of untreated seeds 42. The number of containers 20, 30, 40 may vary—with additional or less containers 20, 30, 40 utilized in some embodiments.

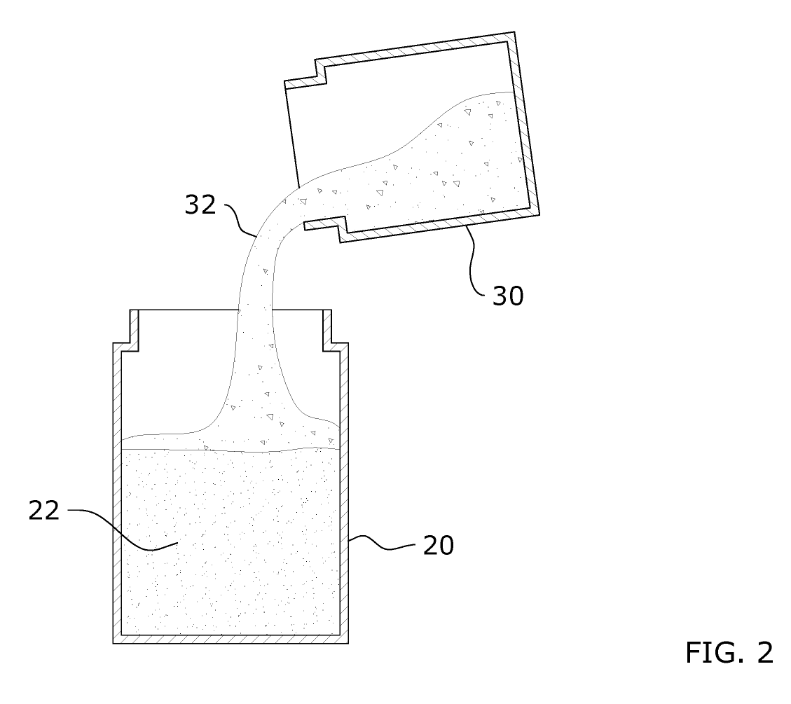

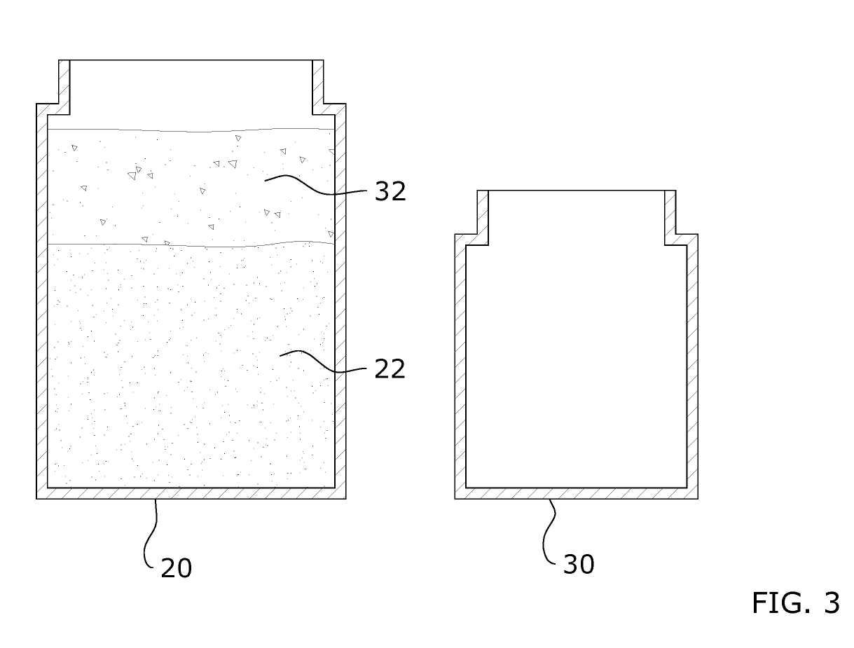

First, the carrier material 22 and seed treatment material 32 are combined. FIG. 2 illustrates the volume of seed treatment material 32 being poured from the second container 30 into the first container 20 storing the volume of carrier material 22. FIG. 3 illustrates both the carrier material 22 and the seed treatment material 32 being stored in the same first container 20. In some embodiments, a separate container may be utilized for the mixing.

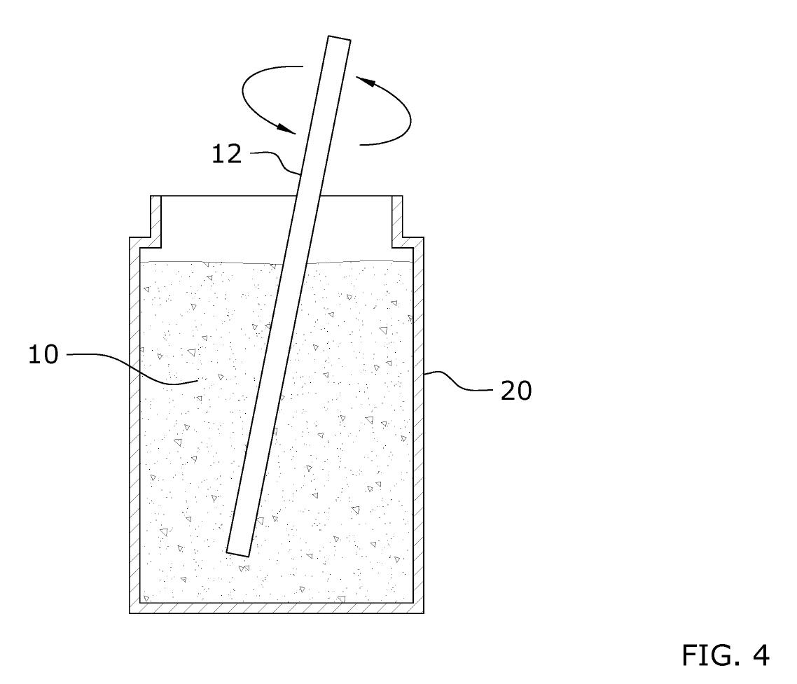

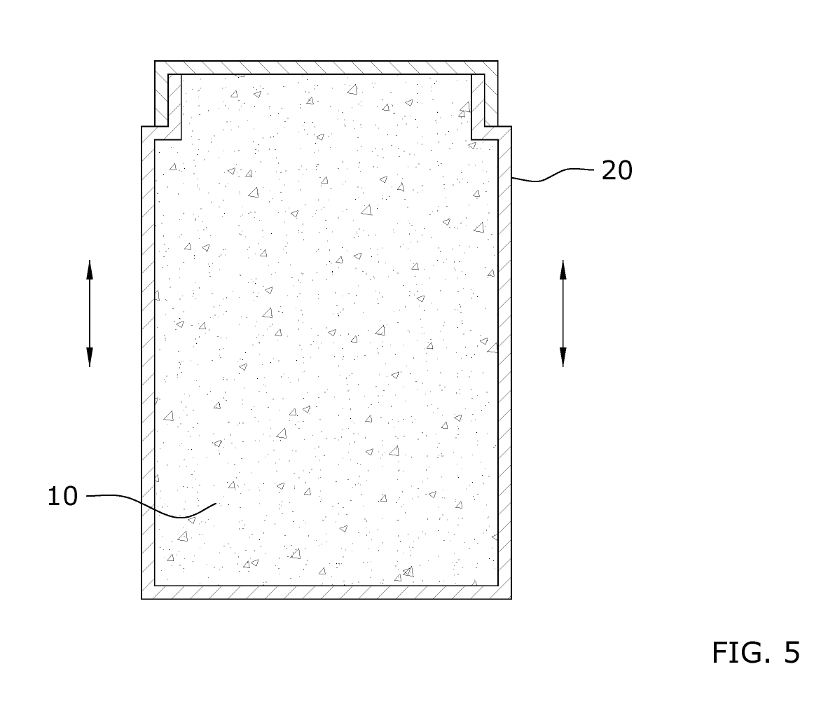

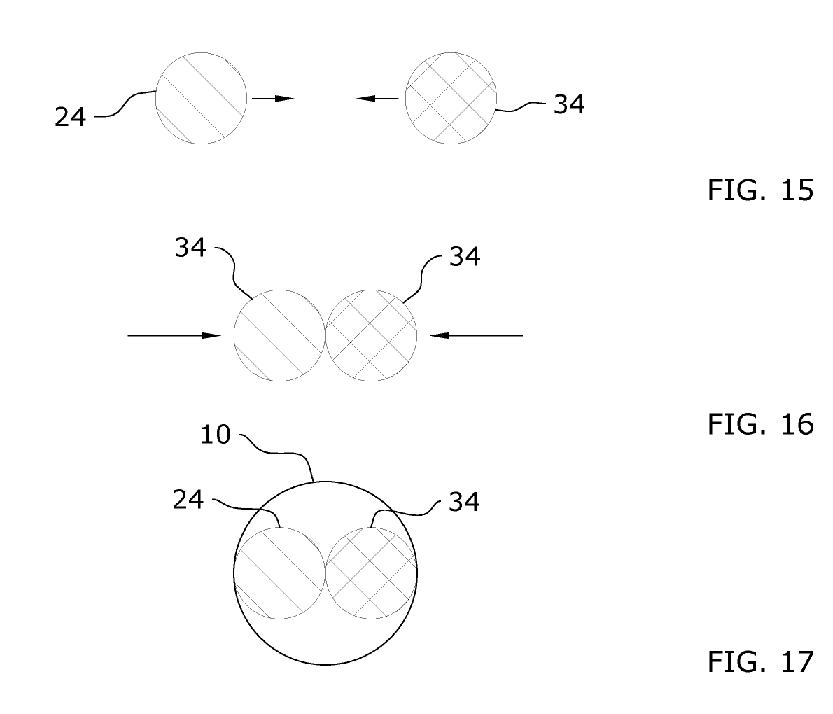

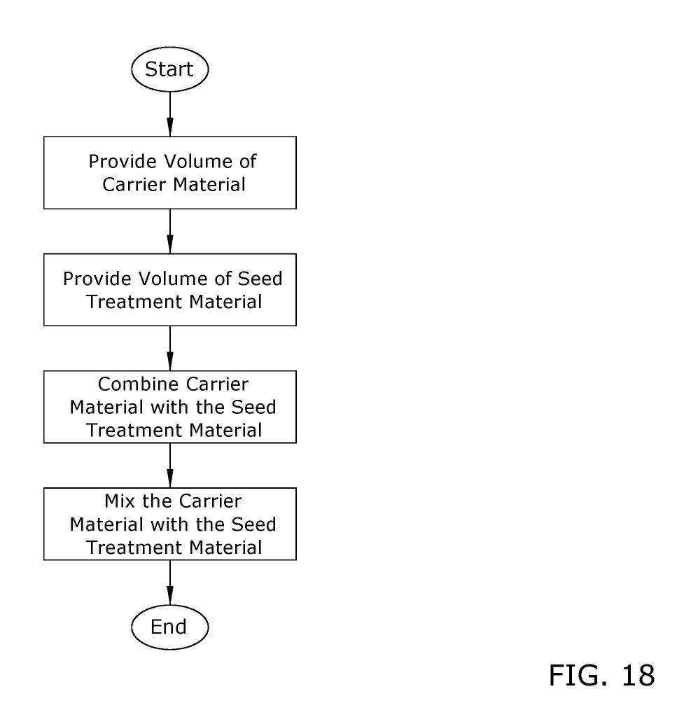

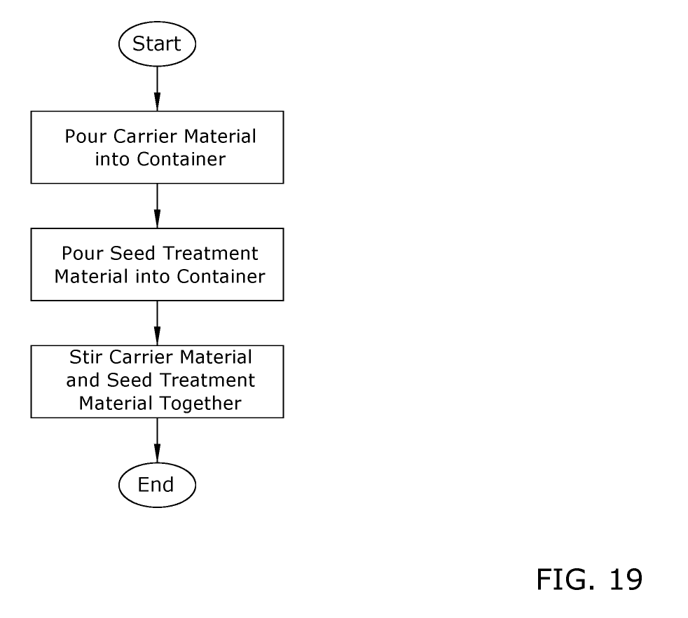

With the carrier material 22 and seed treatment material 32 combined in a container 20, the carrier material 22 and seed treatment material 32 are mixed together such that the carrier particles 24 combine with the seed treatment particles 34 as shown in FIGS. 15-17. The mixing step may be performed in various manners, such as by stirring with a stirrer 12 as shown in FIG. 4, shaking the container 20 as shown in FIG. 5, by passing through an auger, by blending, or by any other method known in the art to mix two solid substances together.

### E. Method of Applying the Seed Treatment Composition to a Seed.

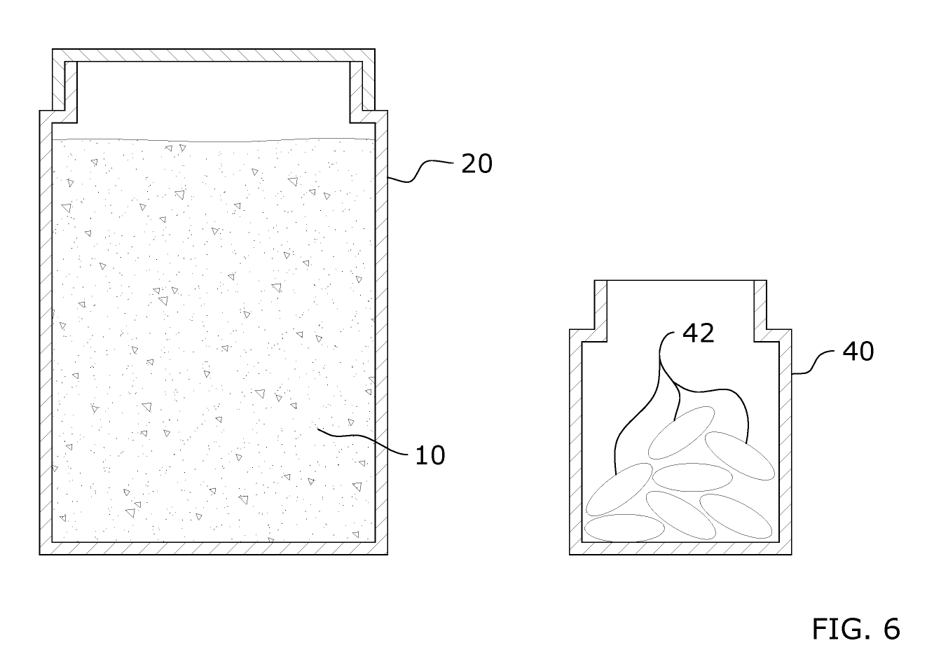

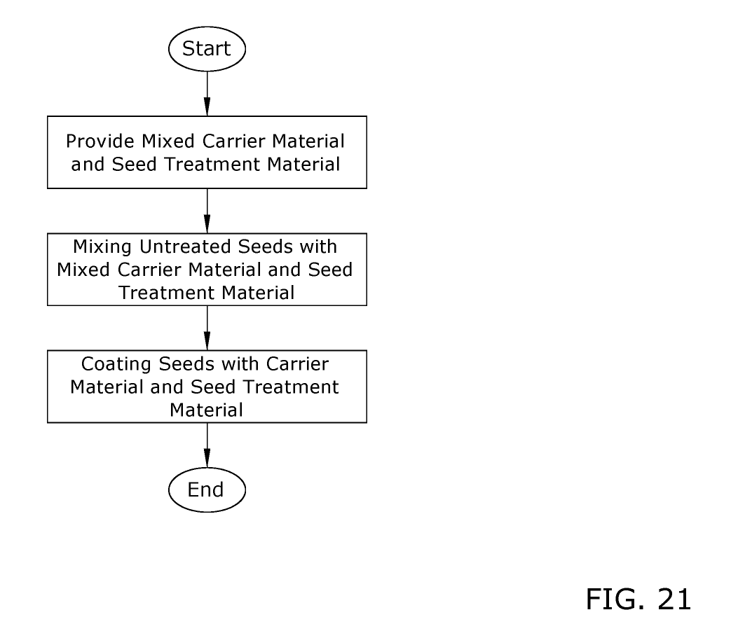

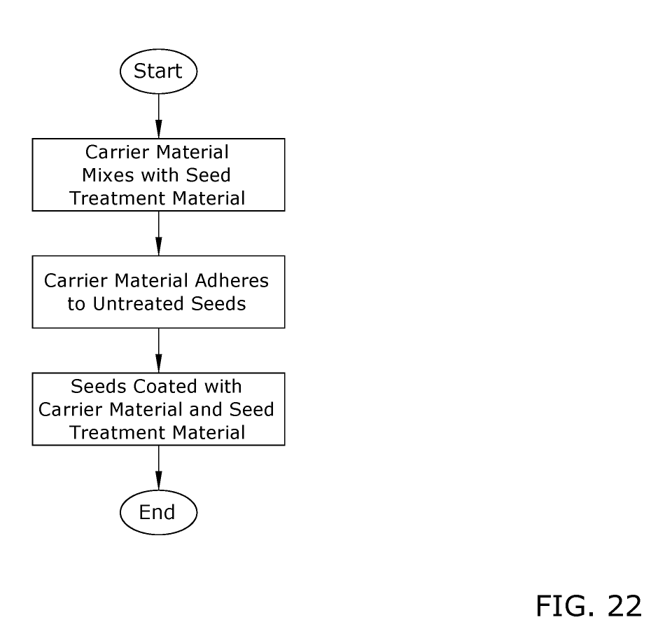

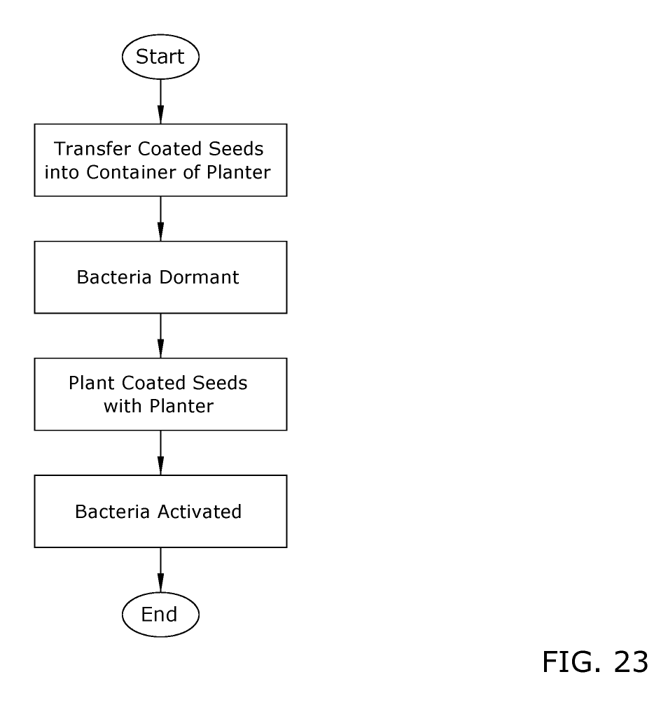

FIGS. 6-9, 11, 21 and 22 illustrate various methods of applying the seed treatment composition 10 to an untreated seed 42. It should be appreciated that the figures and description herein are merely for exemplary purposes; and thus various other methods of application may be utilized to uniformly coat the seed 42 with the seed treatment composition 10.

A method of applying the seed treatment composition 10 to a seed 42 may include providing a volume of the carrier material 22, providing a volume of the seed treatment material 32, providing a volume of seeds 42, mixing the volume of the carrier material 22 with the volume of the seed treatment material 32 to form the seed treatment composition 10, and uniformly coating each of the seeds 42 with the seed treatment composition 10 to form a plurality of coated seeds 44.

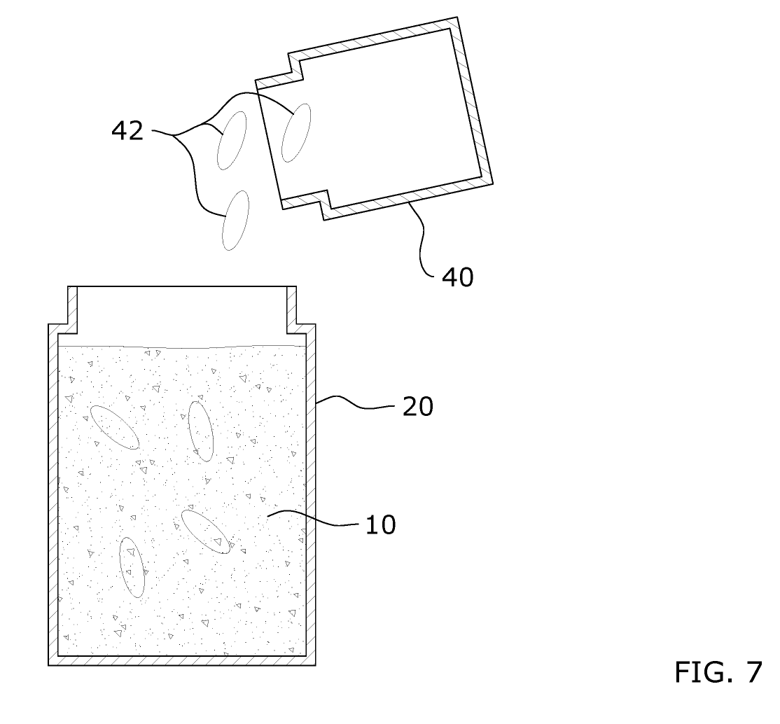

The seed treatment composition 10 is applied to the untreated seeds 42 after the seed treatment composition 10 has been manufactured as described herein. FIG. 6 illustrates a first container 20 storing a volume of seed treatment composition 10 and a third container 40 storing a volume of untreated seeds 42. The untreated seeds 42 are first combined with the seed treatment composition 10 such as shown in FIG. 7. In some embodiments, the seeds 42 are combined with the seed treatment composition 10 in a planter 14 itself. In other embodiments, the seeds 42 may be combined with the seed treatment composition 10 in a container, hopper, or the like.

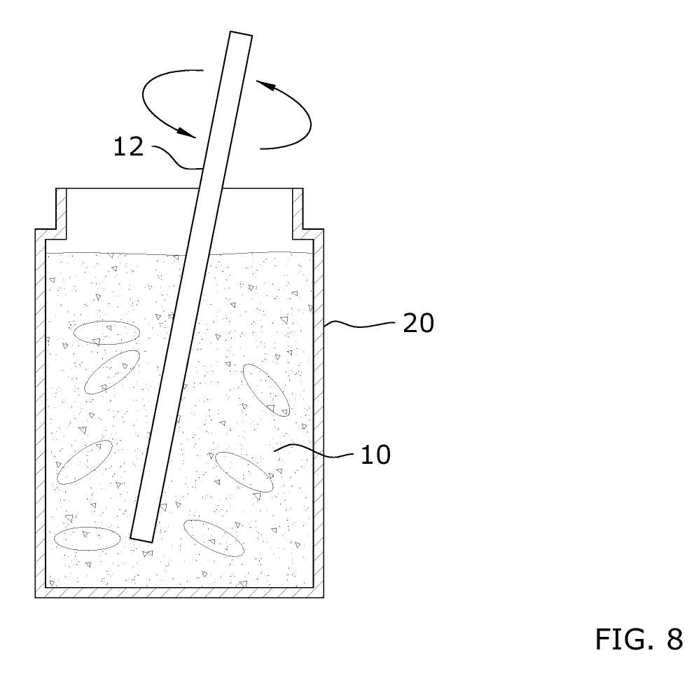

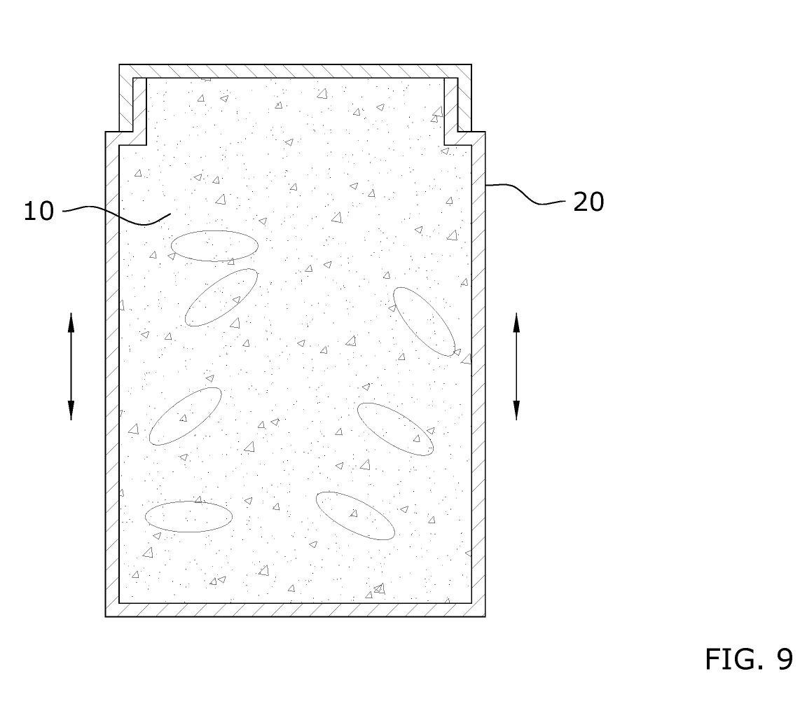

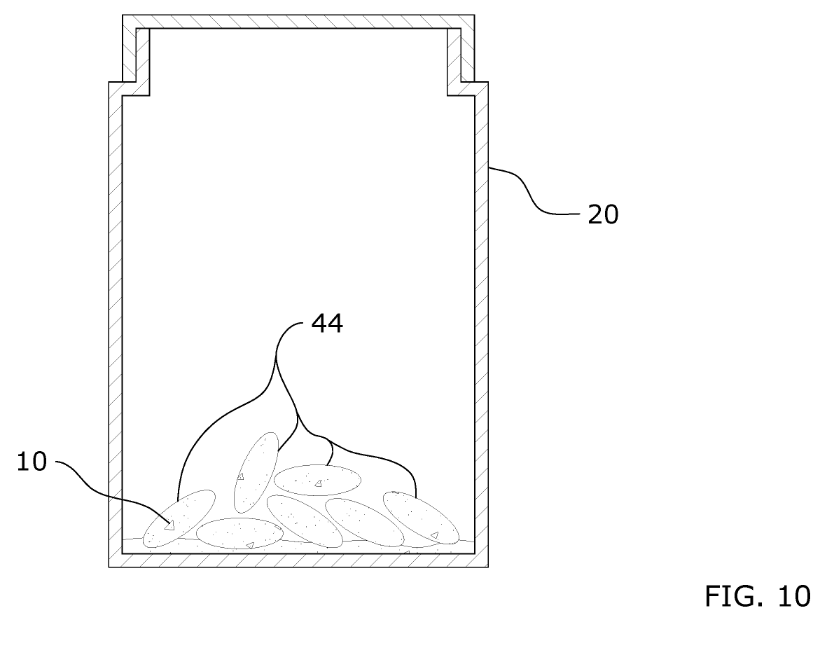

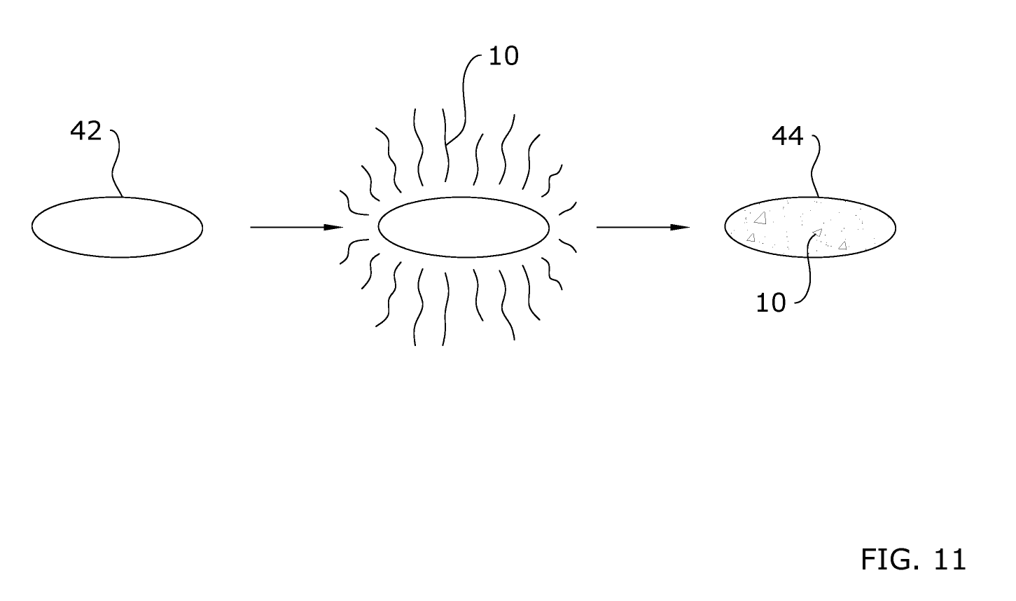

The seed treatment composition 10 should then be coated uniformly on each of the seeds 42. This may be accomplished in a wide range of manners, such as by in an auger, with a blender, by stirring as shown in FIG. 8, or by shaking as shown in FIG. 9. FIG. 10 illustrates the coated seeds 44 being stored in a container 20. The coated seeds 44 may be stored for future use or planted as described below. Any method of coating a seed 42 with a seed treatment composition 10 may be utilized so long as the seed treatment composition 10 adheres to and uniformly coats the exterior of the seed 42 to form the coated seed 44 as shown in FIG. 11.

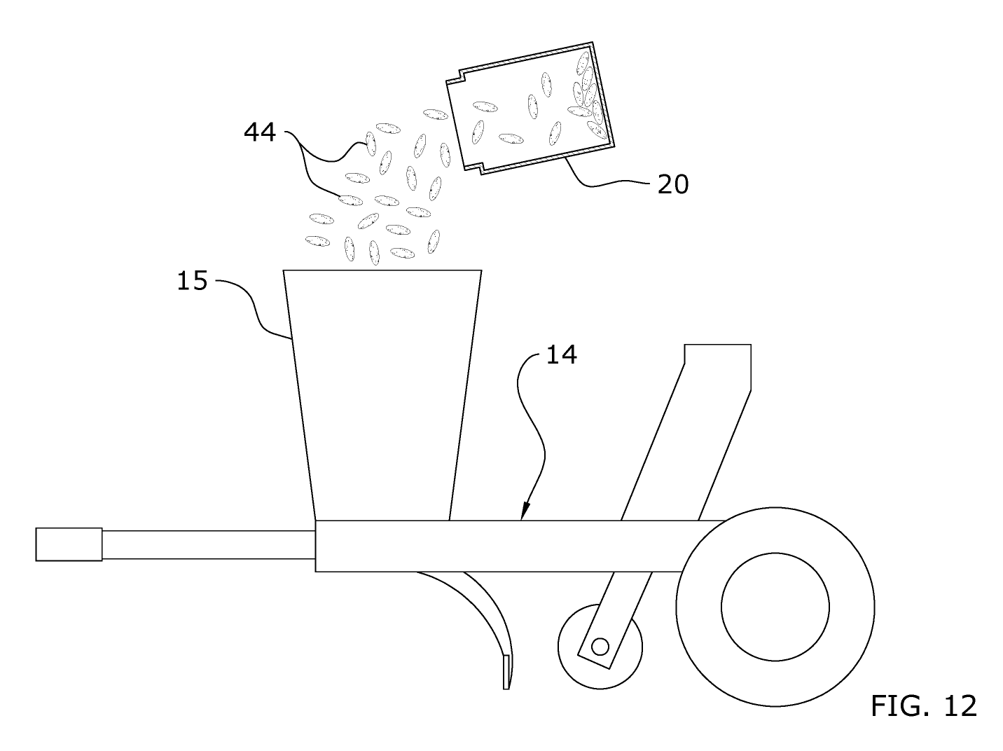

The seed treatment composition 10 may also be applied to the seeds 42 either in the planter 14 or while being fed into a planter 14. FIG. 13 illustrates one exemplary method of coating the seeds 42 with the seed treatment composition 10. As shown, an auger 16 feeds untreated seeds 42 toward the planter container 15. A first container 20 is poured or fed into the auger 16 such that the auger 16 coats the seeds 42 with the seed treatment composition 10 as they are fed into the planter 14. In other embodiments, the seed treatment composition 10 may be applied to the seeds in the planter 14 itself, such as in the planter container 15.

### F. Method of Using the Seed Treatment Composition.

With the seeds 42 having been coated with the seed treatment composition 10 to form coated seeds 44, the coated seeds 44 may then be stored for future use or planted. The talc-based carrier material 22 has been shown to prolong the shelf-life of various seed treatment compositions 10, such as inoculants which should only be activated upon planting in the soil.

A method of using the seed treatment composition 10 may include coating a plurality of seeds 42 with the seed treatment composition 10 to form a plurality of coated seeds 44, filling a container 15 of a planter 14 with the plurality of coated seeds 44, and planting the plurality of coated seeds 44 with the planter 14. If the seed treatment material 32 comprises a bacterium, the bacterium may be dormant until planted and then activated after being planted by the planter 14.

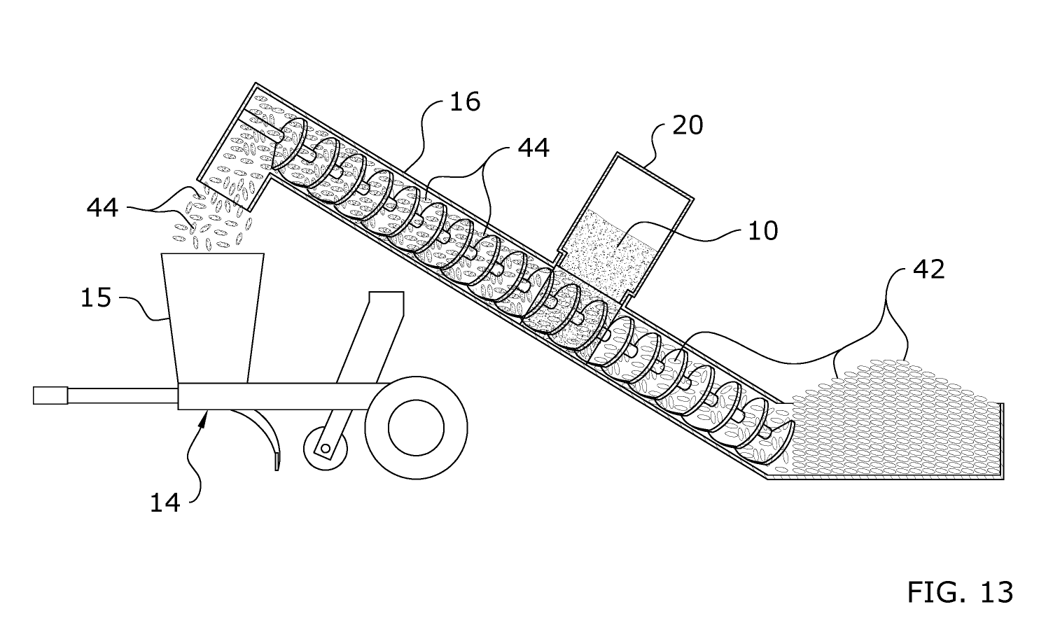

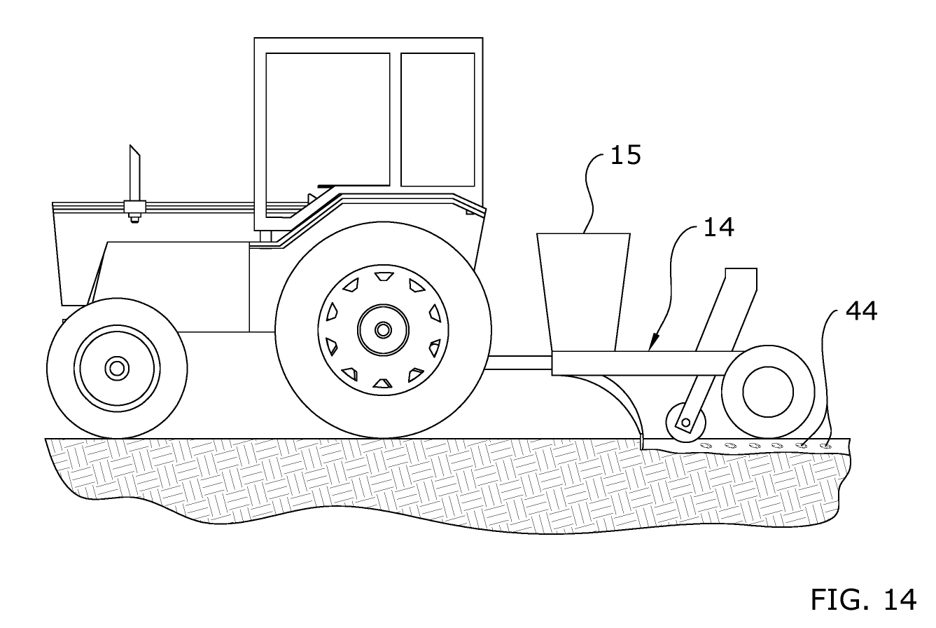

FIGS. 12 and 13 illustrate one exemplary method of planting the coated seeds 44. It should be appreciated that any method known in the art for planting seeds may be utilized, and these figures and descriptions are merely exemplary. In FIG. 12, a planter container 15 such as a hopper is shown being filled with the coated seeds 44. As shown in FIG. 14, the planter 14 may then be used to plant the seeds 44.

Because the coated seeds 44 have lubricant properties from the carrier material 22, the internal passageways of the planter 14 will exert minimal drag on the passing coated seeds 44 to ensure proper seed spacing. Because the coated seeds 44 have hydrophobic properties from the carrier material 22, any moisture within the planter's 14 air systems may be eliminated. Because the coated seeds 44 have anti-static properties, there will be minimal to no accumulation/discharge of static electricity within the planter.

Unless otherwise defined, all technical and scientific terms used herein have the same meaning as commonly understood by one of ordinary skill in the art to which this invention belongs. Although methods and materials similar to or equivalent to those described herein can be used in the practice or testing of the seed treatment composition, suitable methods and materials are described above. All publications, patent applications, patents, and other references mentioned herein are incorporated by reference in their entirety to the extent allowed by applicable law and regulations. The seed treatment composition may be embodied in other specific forms without departing from the spirit or essential attributes thereof, and it is therefore desired that the present embodiment be considered in all respects as illustrative and not restrictive. Any headings utilized within the description are for convenience only and have no legal or limiting effect.

What is claimed is:

1. A seed treatment composition, comprising:
a carrier material comprised of talc, wherein the carrier material is adapted to adhere to and uniformly coat an exterior surface of a seed; and
a seed treatment material mixed with the carrier material, wherein the carrier material and the seed treatment material each comprise solid particulate matter having a substantially similar particle size.

2. The seed treatment composition of claim 1, wherein the carrier material further comprises manganese and iron.

3. The seed treatment composition of claim 2, wherein the carrier material further comprises graphite.

4. The seed treatment composition of claim 1, wherein the seed treatment material is selected from a group consisting of an inoculant, a plant protein, a fungicide, an herbicide, and an insecticide.

5. The seed treatment composition of claim 1, wherein the seed treatment material is comprised of an inoculant.

6. The seed treatment composition of claim 5, wherein the inoculant is comprised of a bacterium.

7. The seed treatment composition of claim 6, wherein the bacterium is dormant until planted.

8. The seed treatment composition of claim 6, wherein the bacterium is comprised of azospirillum.

9. The seed treatment composition of claim 8, wherein the bacterium is comprised of azospirillum brasilense.

10. The seed treatment composition of claim 8, wherein the bacterium is comprised of azospirillum lipoferum.

11. The seed treatment composition of claim 1, wherein the seed treatment material is comprised of a plant protein.

12. The seed treatment composition of claim 11, wherein the plant protein is comprised of a harpin protein.

13. The seed treatment composition of claim 11, wherein the plant protein is comprised of myconate.

14. The seed treatment composition of claim 1, wherein the seed treatment material is comprised of an insecticide.

15. The seed treatment composition of claim 1, wherein the seed treatment material is comprised of an herbicide.

16. The seed treatment composition of claim 15, wherein the herbicide is comprised of sulfentrazone.

17. The seed treatment composition of claim 1, wherein the seed treatment material is comprised of a fungicide.

18. The seed treatment composition of claim 17, wherein the fungicide is comprised of azoxystrobin.

19. A method of manufacturing the seed treatment composition of claim 1, comprising the steps of:
providing a volume of the carrier material;
providing a volume of the seed treatment material;
combining the volume of the carrier material with the volume of the seed treatment material in a container; and
mixing the carrier material with the seed treatment material in the container.

20. The method of claim 19, wherein the mixing step comprises the step of stirring the volume of the carrier material and the volume of the seed treatment material within the container.

21. The method of claim 19, wherein the mixing step comprises the step of shaking the container storing the carrier material and the seed treatment material.

22. A method of using the seed treatment composition of claim 1, comprising the steps of:
coating a plurality of seeds with the seed treatment composition to form a plurality of coated seeds;
filling a container of a planter with the plurality of coated seeds; and
planting the plurality of coated seeds with the planter.

23. The method of claim 22, wherein the seed treatment composition comprises bacterium, wherein the bacterium is activated after being planted by the planter.

24. A method of applying the seed treatment composition of claim 1 to a seed, comprising the steps of:
providing a volume of the carrier material;
providing a volume of the seed treatment material;
providing a volume of seeds;
mixing the volume of the carrier material with the volume of the seed treatment material to form the seed treatment composition; and
uniformly coating each of the seeds with the seed treatment composition to form a plurality of coated seeds.

25. The method of claim 24, further comprising the step of transferring the coated seeds into a container on a planter.
